(19) United States
(12) Patent Application Publication
(10) Pub. No.: US 2014/0127585 A1
(43) Pub. Date: May 8, 2014

(54) POSITIVE ELECTRODE ACTIVE MATERIAL FOR NONAQUEOUS ELECTROLYTE SECONDARY BATTERY, NONAQUEOUS ELECTROLYTE SECONDARY BATTERY, VEHICLE, AND PROCESS FOR PRODUCING NONAQUEOUS ELECTROLYTE SECONDARY BATTERY POSITIVE ELECTRODE ACTIVE MATERIAL

(71) Applicants: Akira Kojima, Kariya-shi (JP); Toshikatsu Kojima, Ikeda-shi (JP); Tomonari Takeuchi, Ikeda-shi (JP); Tetsuo Sakai, Ikeda-shi (JP); Takuhiro Miyuki, Ikeda-shi (JP); Junichi Niwa, Kariya-shi (JP); Kazuhito Kawasumi, Kariya-shi (JP)

(72) Inventors: Akira Kojima, Kariya-shi (JP); Toshikatsu Kojima, Ikeda-shi (JP); Tomonari Takeuchi, Ikeda-shi (JP); Tetsuo Sakai, Ikeda-shi (JP); Takuhiro Miyuki, Ikeda-shi (JP); Junichi Niwa, Kariya-shi (JP); Kazuhito Kawasumi, Kariya-shi (JP)

(73) Assignees: NATIONAL INSTITUTE OF ADVANCED INDUSTRIAL SCIENCE AND TECHNOLOGY, Chiyoda-ku, Tokyo (JP); KABUSHIKI KAISHA TOYOTA JIDOSHOKKI, Kariya-shi, Aichi (JP)

(21) Appl. No.: 14/122,023

(22) PCT Filed: Mar. 16, 2012
(86) PCT No.: PCT/JP2012/001841

§ 371 Date: Nov. 25, 2013

(30) Foreign Application Priority Data
May 26, 2011 (JP) 2011-117854

(51) Int. Cl. H01M 4/36

(52) U.S. Cl. CPC H01M 4/364
USPC 429/231.8; 252/503

(57) ABSTRACT

It is intended to provide a positive electrode active material, which contains a lithium silicate based compound and has superior conductivity, for nonaqueous electrolyte secondary battery, a process for producing the same, and a nonaqueous electrolyte secondary battery using the positive electrode active material. The lithium silicate based compound and a carbon material are mixed at 450 to 16000 rpm for 1 minute to 10 hours and then heated and pressurized at 500° C. to 700° C. at 1 to 500 MPa for 1 minute to 15 hours, thereby adhering the lithium silicate based compound and the carbon material to each other.

### TECHNICAL FIELD

The present invention relates to a positive electrode active material for a nonaqueous electrolyte secondary battery represented by a lithium ion secondary battery as well as a method for producing the positive electrode active material, a nonaqueous electrolyte secondary battery using the positive electrode active material, and a vehicle mounted with the nonaqueous electrolyte secondary battery.

### BACKGROUND ART

As kinds of the nonaqueous electrolyte secondary battery, a lithium secondary battery and a lithium ion secondary battery are known. These nonaqueous electrolyte secondary batteries are small in size and high in energy density and therefore are widely used as a power source for portable electronic appliances. In recent years, lithium silicate based compounds attract attention as a positive electrode active material of the secondary batteries. The lithium silicate based compound attracts attention as a next generation lithium ion secondary battery positive electrode material since it is inexpensive, has a low environmental load because it consists of metal elements of affluent resource volumes, has a higher theoretical charge discharge capacity as compared to Li(NiCo)O₂ based compounds and the like, and is a material which does not release oxygen at high temperatures (for example, see Patent Literatures 1 to 5).

However, despite the above-described excellent properties, the lithium silicate based compound has low conductivity. Therefore, there has been a problem that the nonaqueous electrolyte secondary battery using the lithium silicate based compound as the positive electrode material has a low active material usage rate. It is considered that it is possible to further improve the capacity of the nonaqueous electrolyte secondary battery by improving the conductivity of the positive electrode active material. In order to improve the conductivity of the positive electrode active material, it is considered that blending with a conductive additive such as carbon (C) (for example, see Non-Patent Literature 1) is effective. However, simple blending of the conductive additive such as carbon (C) with the lithium silicate based compound results in weak bonding between the materials and does not attain any prominent improvement in conductivity.

Accordingly, there is a demand for a positive electrode active material which contains the lithium silicate based compound and is superior in conductivity.

### PRIOR ART DOCUMENTS

### Patent Literatures

Patent Literature 1: JP 2008-218303 A

Patent Literature 2: JP 2007-335325 A

Patent Literature 3: JP 2001-266882 A

Patent Literature 4: JP 2008-293661 A

Patent Literature 5: WO 2010/089931

### Non Patent Literature

Non Patent Literature 1: “Synthesis of Composite Particles of Lithium Iron Silicate and Carbon and Properties of Lithium Secondary Battery containing the Composite Particles”; Bin Shao, Izumi TANIGUCHI; The Society of Chemical Engineers, Japan; Abstracts of Research Presentations of 75^{th} Meeting.

### SUMMARY OF THE INVENTION

### Problems to be Solved by the Invention

An object of the present invention is to provide a nonaqueous electrolyte secondary battery positive electrode active material which contains a lithium silicate based compound and has superior conductivity and a nonaqueous electrolyte secondary battery using the positive electrode active material.

### Means for Solving the Problems

A nonaqueous electrolyte secondary battery positive electrode active material of the present invention which solves the above-described problem is characterized by comprising a lithium silicate based compound including lithium (Li), silicon (Si), oxygen (O), and a divalent transition metal element, and a carbon material including carbon (C), and having two peaks in a particle size distribution measured by a laser diffraction/scattering particle size distribution measurement method.

A nonaqueous electrolyte secondary battery of the present invention which solves the above-described problem is characterized in that a positive electrode thereof comprises the positive electrode active material of the present invention.

A method of the present invention for producing the nonaqueous electrolyte secondary battery positive electrode active material which solves the above-described problem is characterized by comprising:
a mixing step of mixing a lithium silicate based compound including lithium (Li), silicon (Si), oxygen (O), and a divalent transition metal element, with a carbon material including carbon (C) at 450 to 16000 rpm for 1 minute to 10 hours; and
a heating and pressurizing step of heating and pressurizing the mixture after the mixing step at 500° C. to 750° C. at 1 to 500 MPa for 1 minute to 15 hours.

### Effects of the Invention

The nonaqueous electrolyte secondary battery positive electrode active material of the present invention has superior conductivity. Also, the nonaqueous electrolyte secondary battery of the present invention has a large charge-discharge capacity.

### BRIEF DESCRIPTION OF THE DRAWINGS

FIG. 1 is a diagram schematically illustrating a typical mechano-fusion apparatus;

FIG. 2 is a diagram schematically illustrating a typical spark plasma sintering apparatus;

FIG. 3 is a graph illustrating a particle size distribution of a positive electrode active material of Example (#1) measured by a laser diffraction/scattering particle size distribution measurement method;

FIG. 4 is a graph illustrating a particle size distribution of the positive electrode active material of Example (#2) measured by the laser diffraction/scattering particle size distribution measurement method;

FIG. 5 is a graph illustrating a particle size distribution of the positive electrode active material of Example (#3) measured by the laser diffraction/scattering particle size distribution measurement method;

FIG. 6 is a graph illustrating a particle size distribution of a positive electrode active material of Comparative Example (#1) measured by the laser diffraction/scattering particle size distribution measurement method;

FIG. 7 is a graph illustrating a particle size distribution of the positive electrode active material of Comparative Example (#2) measured by the laser diffraction/scattering particle size distribution measurement method;

FIG. 8 is a graph illustrating a particle size distribution of the positive electrode active material of Comparative Example (#3) measured by the laser diffraction/scattering particle size distribution measurement method;

FIG. 9 is a diagram illustrating an SEM image of the positive electrode active material of Example;

FIG. 10 is a diagram illustrating an SEM image of the positive electrode active material of Example;

FIG. 11 is a diagram illustrating an SEM image of the positive electrode active material of Comparative Example;

FIG. 12 is a diagram illustrating an SEM image of the positive electrode active material of Comparative Example;

FIG. 13 is a graph illustrating internal resistances when lithium secondary batteries of Example and Comparative Example are charged;

FIG. 14 is a charge-discharge curve of the lithium secondary battery of Example; and

FIG. 15 is a charge-discharge curve of the lithium secondary battery of Comparative Example.

### MODES FOR CARRYING OUT THE INVENTION

It is considered that it is preferable to increase a carbon amount to be mixed with a lithium silicate based compound in order to improve conductivity, but a bulk density of a positive electrode active material is reduced (the positive electrode active material becomes bulky) when the carbon amount is increased. The reduced bulk density of the positive electrode active material entails problems such as difficulty in forming an electrode and a reduction in charge-discharge capacity of the nonaqueous electrolyte secondary battery caused by the reduction in amount of the positive electrode active material in the positive electrode composite material.

The inventors of the present invention found that it is possible to obtain a composite material having a large bulk density and superior conductivity by well mixing the lithium silicate based compound with the carbon material and then heating and pressurizing the mixture. Also, they found that it is possible to improve a charge-discharge capacity of a nonaqueous electrolyte secondary battery by using the composite material as the positive electrode active material. Further, they found that it is possible to improve various properties of a vehicle by mounting the nonaqueous electrolyte secondary battery which is improved in charge-discharge capacity as described above on the vehicle. The step of mixing the lithium silicate based compound with the carbon material is referred to as “mixing step”, and the step of heating and pressurizing after the mixing step is referred to as “heating and pressurizing step”.

<Positive Electrode Active Material and Production Method>

In the mixing step, the lithium silicate based compound and the carbon material are well mixed with each other. More specifically, the materials are mixed at 450 to 16000 rpm for 1 minute to 10 hours. The number of rotations means that of a stirrer. By the step, mechanical energy is caused to act on the lithium silicate based compound and the carbon material, and the materials are rubbed or compressed with each other (or receive other actions) to be composited, thereby giving a mixture in the form of particles. The mixture of the lithium silicate based compound and the carbon material obtained by this step is referred to as mixed particles.

As a mixing apparatus to be used for the mixing step, the one called mechano-fusion (surface fusion) apparatus may preferably be used. Hereinafter, the mixing step (mechano-fusion treatment) using the mechano-fusion apparatus will specifically be described.

### <<Mechano-Fusion Treatment>>

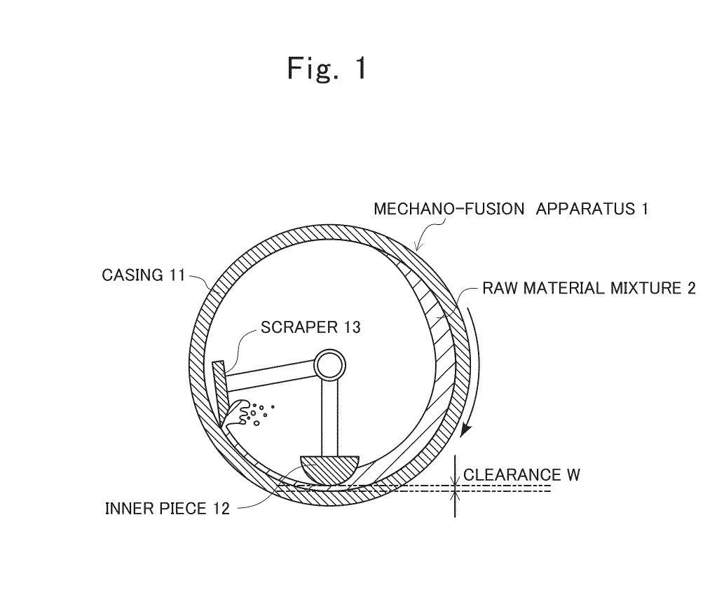

The mechano-fusion treatment is a treatment method, in which mechanical energy (mechanical stress) applied between different kinds of particles causes the particles to pass through a narrow space repeatedly at a high speed, thereby producing mixed particles in which different kinds of particles bind to each other. In the present invention, the treatment means the one for obtaining the mixed particles, in which at least a compression force and a shearing force are applied to the raw material mixture containing the lithium silicate based compound (i.e. electrode active material) and the carbon material (i.e. conductive material) in order to bind the lithium silicate based compound and the carbon material to each other. Shown in FIG. 1 is a diagram schematically illustrating a typical mechano-fusion apparatus. Hereinafter, the mechano-fusion apparatus will be described based on FIG. 1.

As shown in FIG. 1, the mechano-fusion apparatus 1 is provided with a casing 11, an inner piece 12, and a scraper 13. The casing 11 is a container for housing a raw material mixture 2 and is capable of high speed rotation. The inner piece 12 is a friction member having a substantially semi-columnar shape and is fixed inside the casing 11. The scraper 13 is a scraping member and is fixed inside the casing 11 together with the inner piece 12. The casing 11 rotates relative to the inner piece 12 and the scraper 13. In order to suppress an abnormal temperature rise which can be caused by frictional heat, a cooling unit (not shown) enclosing the casing 11 may be provided outside the casing 11.

The raw material mixture 2 is supplied to the casing 11, and then the raw material mixture 2 is pressed against an inner wall of the casing 11 by a centrifugal force caused by the high speed rotation of the casing 11 to be deposited in the form of layers. Rotation conditions of the casing 11 may preferably be but are not limited to about 450 to 16000 rpm, more preferably 2000 to 7000 rpm. During the rotation of the casing 11, the raw material mixture 2 receives the mechanical stress (specifically, at least a compression force and a shearing force) at a clearance (clearance W) between the inner piece 12 and the casing 11. The raw material mixture 2 after receiving the mechanical stress is scraped off with the scraper 13 and then mixed with the raw material mixture 2 again. By repeating the operation continuously, the mixed particles in which the lithium silicate based compound and the carbon material are uniformly dispersed and firmly bonded to each other is obtained.

In order to more uniformly disperse the lithium silicate based compound and the carbon material and simultaneously to attain firmer bonding between them, the clearance W between the casing 11 and the inner piece 12 may preferably be about 0.1 to 10 mm, more preferably 0.2 to 8 mm.

As for the mechano-fusion apparatus, for example, the powder processing apparatus described in JP 63-42728 A can be given. More specifically, the mechano-fusion system manufactured by Hosokawa Micron Group is suitably used.

Since the carbon material is forced into the inside of the lithium silicate based compound as a result of the mixing step performed by using the apparatus, the mixed particles in which the carbon material is finely dispersed on a surface and the inside of the lithium silicate based compound can be obtained. A particle diameter of the mixed particles obtained by the mixing step may preferably be small. More specifically, a value of a volume cumulative frequency D50 measured by the laser diffraction/scattering particle size distribution measurement method may preferably be 1.6 μm or more and 2.0 μm or less. More preferably, D50 is 1.65 μm or more and 1.9 μm or less. The mixed particles having the small particle diameter have the advantage of forming a larger number of conductive paths since such mixed particles have a large surface area per volume and therefore have many contact points with the carbon material. Also, with the small particle diameter of the mixed particles, an average distance of movement of Li from the inside to the surface of the active material particle during charge-discharge is shortened to bring the advantages of an improvement in active material usage rate and an improvement in output characteristics.

In order to obtain the fine mixed particles in which high level adhesion between the lithium silicate based compound and the carbon material is attained, the number of rotations of the mechano-fusion apparatus may preferably be 1000 to 10000 rpm, more preferably 3000 to 8000 rpm. Also, a stirring time may preferably be 1 minute to 1 hour, more preferably 5 to 30 minutes. When the mixing time is too short, the lithium silicate based compound and the carbon material do not satisfactorily adhere to each other in some cases. When the mixing time is too long, there are possibilities that mixed particles having excessively small particle diameter are generated due to coming off of corners of the mixed particles and that the carbon material comes off from the mixed particles.

In the heating and pressurizing step, the mixed particles after the mixing step are heated and pressurized. More specifically, the mixed particles are heated and pressurized at 500° C. to 750° C. at 1 to 500 MPa for one minute to 15 hours. By the step, a large number of the mixed particles are sintered and bonded to give the positive electrode active material in the form of secondary particles in which a plurality of the mixed particles are integrated. A bulk density of the particles (positive electrode active material) after the heating and pressurizing step is larger than the bulk density of the mixed particles. In other words, the positive electrode active material of the present invention is less bulky as compared to the mixed particles. As the reasons for the less bulkiness, it is considered that the mixed particles adhere each other to be firmly bonded to each other and that adhesion between the carbon material and the lithium silicate based compound contained in the mixed particles is improved as a result of simultaneously performing the heating and the pressurization.

The heating and pressurizing step may be performed by employing electric current sintering and using a heating and pressurizing apparatus. The electric current sintering will be described below.

### <<Electric Current Sintering>>

As the electric current sintering (electric current bonding), pressure sintering in which a pulsed direct current is supplied, such as spark plasma sintering (SPS), spark sintering, and plasma activated sintering, is known. More specifically, the electric current sintering may be any one capable of charging a conductive heating and pressurizing mold with a sample (mixed particles in the present invention) and supplying a pulsed ON-OFF direct current while pressurizing the sample to enable the electric current sintering under pressure. The electric current sintering apparatus and the operating principle thereof are disclosed in JP 10-251070 A, for example.

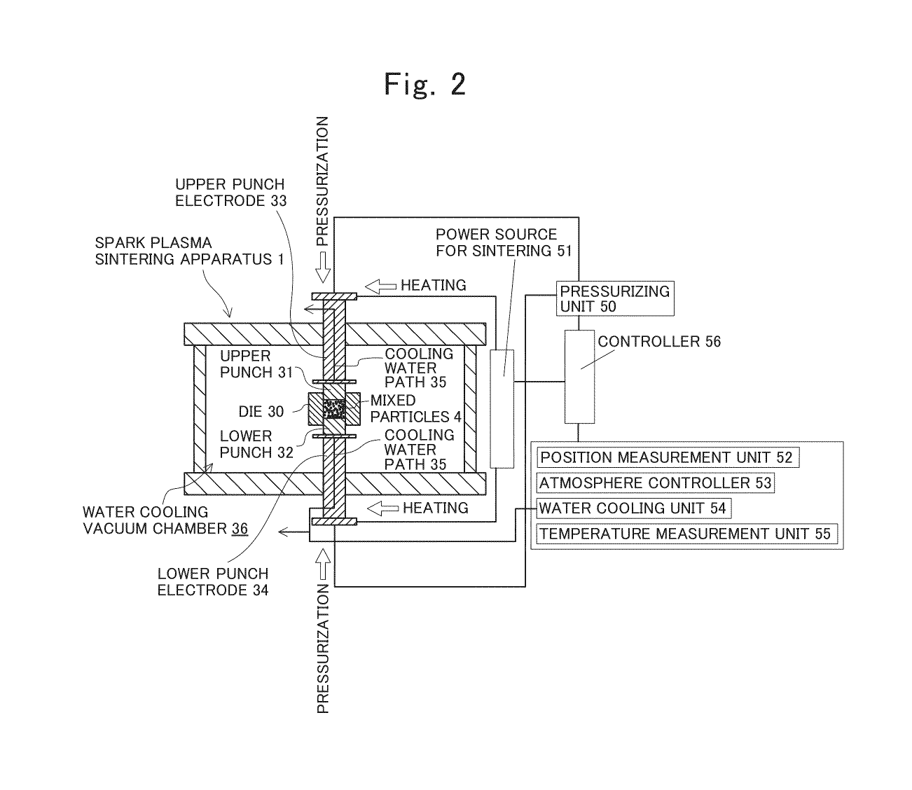

Shown in FIG. 2 is a diagram schematically illustrating a typical spark plasma sintering apparatus. The spark plasma sintering apparatus 3 shown in FIG. 2 is provided with a die 30 and a pair of punches (upper punch and lower punch 32). The die 30 is a heating and pressurizing mold which is to be charged with the mixed particles 4 and is opened in a vertical direction. The upper punch 31 is disposed above the opening of the die 30 and is capable of vertical movement. The lower punch 32 is disposed below the opening of the die 30 and is capable of vertical movement. A cavity which is to be charged with the mixed particles 4 is defined by the die 30, the upper punch 31, and the lower punch 32. A pair of punch electrodes (upper punch electrode 33, lower punch electrode 34) are connected to a pressurizing unit 50 respectively. Therefore, the punches (31, 32) receive a driving force from the pressurizing unit 50 via the punch electrodes (33, 34), respectively, and enter the inside of the die 30 to pressurize the mixed particles 4. Also, the pair of punches (31, 32) are supported by the punch electrodes (33, 34), respectively, and receives electric supply from a sintering power source 51 via the punch electrodes (33, 34) to be electrified. Here, the die 30 and the mixed particles 4 adjacent to the punches (31, 32) are also electrified. The electrified punches (31, 32) and the die 30 are heated, and the mixed particles 4 inside the cavity are also heated. In short, the mixed particles 4 are electrified and heated by the pair of punches (31, 32) and the die 30. An electrically-sintered substance (i.e. the positive electrode active material of the present invention) is obtained by the heat and the electric current. Note that the spark plasma sintering apparatus 1 is provided also with a position measurement unit 52, an atmosphere controller 53, a water cooling unit 54, a temperature measurement unit 55, and a controller 56. The position measurement unit 52 measures the position of the lower punch electrode 34. The atmosphere controller 53 is connected to a not-shown gas cylinder and the cavity to supply an inert gas to the cavity. The water cooling unit supplies cooling water to a cooling water path 35 provided inside the punch electrodes (33, 34) and a water cooling vacuum chamber 36 to suppress excessive heating of the parts. The temperature measurement unit 55 measures a temperature near a surface of the die 30. The pressurizing unit 50, the sintering power source 51, the position measurement unit 52, and the atmosphere controller 53 are so controlled by the controller 56 as to supply the inert gas after a pressure in the water cooling vacuum chamber 36 is reduced. The water cooling unit 54 and the temperature measurement unit are incorporated into the controller 56, and the measurement and the control are performed by the controller 56.

In the case of performing the heating and pressurizing step by employing the electric current sintering, the pulsed current may preferably be used as the current. As the pressure in the step, a pressure of 1 MPa or more is satisfactory, and a pressure of 30 MPa or more is preferable. Hereinafter, a method and a device for performing the electric current sintering under a pressure of 30 MPa or more on the mixed particles (bound powder of lithium silicate based compound and carbon material) will specifically be described.

As the heating and pressurizing mold (die 30 in FIG. 2) used in the electric current sintering, the one which has superior electronic conductivity and endures a pressure of 30 MPa or more is satisfactory, and a material and a shape of the mold are not particularly limited. For example, carbon, tungsten carbide, an aluminum alloy represented by an Al-Cu-Mg-based alloy, and the like may preferably be used for the mold.

By applying a pulsed direct current to the heating and pressurizing mold having electronic conductivity, a discharge phenomenon occurs at a space between the mixed particles charged in the heating and pressurizing mold. The discharge phenomenon causes a cleaning and activating action to be exerted on particle surfaces due to spark plasma, discharge impact, and the like, an electric field diffusion effect caused by an electric field, a heat diffusion action caused by Joule's heat, a plastic deformation pressure caused by pressurization, and the like. It is considered that the forces become the driving force to bond the silicate based compound particles contained in the mixed particle via the carbon material. More specifically, with the pulsed current application, a part of the carbon material as the conductive material is vaporized to be deposited on (to coat) the surfaces of the silicate based compound. The carbon material in the mixed particles firmly adheres to the carbon material deposited on the surfaces of the silicate based compound. It is considered that the reaction occurs continuously to cause the silicate based compound particles to be firmly bonded each other via the carbon material and also to cause the silicate based compound and the carbon material to be firmly bonded each other. It is considered that the silicate based compound can be slightly sintered; however, it is considered that the adjacent silicate based compound particles are seldom sintered and almost all of the silicate based compound particles are bonded via the carbon material.

In order to heat the mixed particles while pressurizing the mixed particles (heating and pressuring step) in the process of the present invention, the current application to the mixed particles is performed during the pressurization. A pressure in the pressurization may preferably be 30 MPa or more. A higher pressure is preferred in order to more firmly bond the silicate based compound to the carbon material, but an excessively high pressure can cause breakage of the heating and pressurizing apparatus (for example, the die 30 in FIG. 2). Therefore, a preferred range of the pressure in the heating and pressurizing step has the upper limit. The pressure in the heating and pressurizing step in the process of the present invention may preferably be 500 MPa or less.

A temperature of the heating and pressurizing mold (for example, the die 30 in FIG. 2) for supplying the electric current to the mixed particles may appropriately be selected depending on kinds, particle size and the like of the silicate based compound and the carbon material, however the bonding between the silicate based compound and the carbon material can be unsatisfactory in some cases when the temperature is less than 100° C. When the temperature exceeds 800° C., the silicate based compound can be decomposed due to reduction of the carbon material and the heating and pressurizing mold. Therefore, the heating temperature in the heating and pressurizing step may preferably be about 100° C. to 800° C., more preferably about 150° C. to 700° C.

As the pulsed current to be applied for the heating, a pulsed ON-OFF direct current having a pulse width of about 2 to 3 ms and a cycle of about 3 to 500 Hz is usable. The current value may appropriately be set depending on a material and a size of the heating and pressurizing mold. For example, in the case of using a heating and pressurizing mold having an inner diameter of 10 mm and made from tungsten carbide, the current value may preferably be about 300 to 1000 A. In the case where the inner diameter is 20 mm, the current value may preferably be about 500 to 3000 A. Preferably, during the current application, the current value is fluctuated while monitoring the temperature of the heating and pressurizing mold so as to control the current value to keep the temperature within the predetermined range, or an input electric energy quantity (Wh value) is controlled. Since a sintering time in the electric current sintering varies depending on the amount and the sintering temperature of the mixed particles, it is difficult to unconditionally define the sintering time. However, as the sintering time, the heating temperature is generally kept within the above-specified heating temperature range for about 1 to 2 minutes.

Preferably, the mixed particles (i.e. the positive electrode active material) after the heating and pressurizing step by the electric current sintering is taken out from the heating and pressurizing mold after cooling and then is lightly pulverized using a mortar or the like to be used as the positive electrode active material for nonaqueous electrolyte secondary batteries. In the case of subjecting a large amount of the mixed particles to the heating and pressuring step by the electric current sintering at once, a large size heating and pressuring mold may be used for scaling up the above-described step. The pressure, the temperature, the current value, and the heating time may appropriately be set depending on the amount of the mixed particles, the type of the heating and pressurizing mold, and the size of the heating and pressurizing mold.

With the sintering employing the above-described method, the adhesion between the lithium silicate based compound and the carbon material is improved. The carbon material contained in one of the mixed particles adheres to the carbon material contained in the adjacent mixed particle to form a number of conductive paths. Therefore, the positive electrode active material superior in conductivity is obtained.

Apart from the electric current sintering, a heating and pressurizing method using a hot pressing apparatus may be employed. In the case of performing the heating and pressurizing step using the hot pressing apparatus, a heating and pressurizing time may preferably be 30 minutes to 30 hours. A pressure in the heating and pressuring step may preferably be 10 to 500 MPa, more preferably be 20 to 50 MPa.

The positive electrode active material of the present invention is obtained from the mixing step and the heating and pressurizing step described above. At least a part of the positive electrode active material is in the form of a secondary particle which is obtained by the bonding between or among a plurality of the mixed particles. Therefore, the positive electrode active material of the present invention has two peaks in a particle size distribution measured by the laser diffraction/scattering particle size distribution measurement method. The peak of the smaller particle size is considered to be the peak of the primary particles (mixed particle), and the peak of the larger particle size is considered to be the peak of the secondary particles (aggregate of mixed particles). By forming the secondary particles each of which is the aggregate of the mixed particles, the number of conductive paths each of which is formed by the carbon material contained in each of the mixed particles is increased, and, thus, the conductivity of the positive electrode active material formed by the particles is improved. Also, since the secondary particles are formed, the lithium silicate based compound and the carbon material firmly adhere to each other. Further, a bulk density (tap density) of the mixed particles is increased owing to the formation of the secondary particles.

The mixing step and the heating and pressuring step may preferably be performed under an atmosphere which hardly or never causes a side reaction, and specifically, it may preferably be performed under an inert atmosphere such as nitrogen gas, argon gas, and carbon dioxide gas atmospheres.

The positive electrode active material of the present invention is prepared by using as the materials the lithium silicate based compound and the carbon material. The lithium silicate based compound means a compound containing Li, Si, 0, and a divalent transition metal element. As the divalent transition metal element, at least one may be selected from the group consisting of Mn, Fe, and Co. The lithium silicate based compound in the positive electrode active material of the present invention may consist of Li, Si, O, and the divalent transition metal element, such as Li₂FeSiO₄ and Li₂MnSiO₄, but other elements may be contained therein. Also, two kinds of the divalent transition metal element may be contained.

For example, as the lithium silicate based compound containing Fe and Mn as the divalent transition metal elements, a lithium iron silicate-based lithium manganese silicate based compound represented by a composition formula: Li₂Fe₁₋ₓMnₓSiO₄ (wherein x is one of 0, 0.3, 0.5, 0.7, and 1) is known. Also, as the lithium silicate based compound containing Mn and an element other than iron as the divalent transition metal elements, a lithium manganese silicate based compound represented by a composition formula Li_{2+a-b}A_{b}Mn₁₋ₓMₓSi_{1+α}O_{4+c} (wherein A is at least one kind of element selected from the group consisting of Na, K, Rb, and Cs; M is at least one kind of element selected from the group consisting of Mg, Ca, Co, Al, Ni, Nb, Ti, Cr, Cu, Zn, Zr, V, Mo, and W; and, for the subscripts, 0≦x≦0.5, −1<a<1, 0≦b<0.2, and 0≦c<1, 0<α≦0.2 are satisfied) is known. As the positive electrode active material of the present invention, these lithium manganese silicate based compounds are also usable.

As the carbon material, a material similar to the conductive agent which is used for electrodes of nonaqueous electrolyte secondary batteries may preferably be used without particular limitation thereto. For example, acetylene black (AB), Ketjen black (KB), a vapor grown carbon fiber (VGCF), and the like are preferably used.

A ratio of the carbon material to the lithium silicate based compound may preferably be, but is not particularly limited to, 2 to 50 parts by mass, more preferably 5 to 30 parts by mass, relative to 100 parts by mass of the lithium silicate based compound. As described in the foregoing, the capacity of the nonaqueous electrolyte secondary battery can be reduced to cause the possibility of a reduction in volume energy density when the ratio of the carbon material is excessively large. Also, when the ratio of the carbon material is excessively small, it is difficult to satisfactorily improve the conductivity to cause the possibility of insufficient improvement in active material usage rate.

### <Positive Electrode for Nonaqueous Electrolyte Secondary Battery>

The positive electrode active material of the present invention contains the lithium silicate based compound and the carbon material and is effectively used as the positive electrode active material for nonaqueous electrolyte secondary batteries. A positive electrode comprising the positive electrode active material may have a configuration similar to that of an ordinary nonaqueous electrolyte secondary battery.

For example, it is possible to produce the positive electrode by preparing a paste by adding, to the above-described positive electrode active material of the present invention, a polyvinylidene difluoride (PVdF), polytetrafluoroethylene (PTFE), a binder such as a styrene-butadiene rubber (SBR), and a solvent such as N-methyl-2-pyrrolidone (NMP) and coating a current collector with the paste. A conductive additive may be added, but, since the carbon material is contained in the positive electrode active material, it is not necessary to add the conductive additive. An amount of the binder to be used may be 5 to parts by mass relative to 100 parts by mass of the positive electrode active material of the present invention, for example, without particular limitation thereto. Also, as another manner, it is possible to produce the positive electrode by preparing a mixture of the positive electrode active material of the present invention and the binder (and the conductive additive, etc. as required), forming the mixture into a film by kneading using a motor and a presser, and compression-bonding the film to the current collector by using a presser.

For the current collector, a material which has heretofore been used for the nonaqueous electrolyte secondary battery positive electrodes, such as aluminum foil, an aluminum mesh, and a stainless mesh may be used without particular limitation thereto. As another manner, a current collector using a carbon material such as a nonwoven carbon fabric and a woven carbon fabric may be used.

A shape, a thickness, and the like of the positive electrode using the positive electrode active material of the present invention are not particularly limited, but the thickness may preferably be adjusted to 10 to 200 μm, more preferably 20 to 100 μm, by performing compression after charging the active material. Therefore, an amount of the active material to be charged is appropriately decided so that the above-specified thickness is achieved after the compression depending on the kind, configuration, and the like of the current collector to be used.

### <Nonaqueous Electrolyte Secondary Battery>

It is possible to produce a nonaqueous electrolyte secondary battery using the above-described positive electrode containing the positive electrode active material by a known method. For example, in the case where the nonaqueous electrolyte secondary battery is a lithium secondary battery or a lithium ion secondary battery, the above-described positive electrode is used as a positive electrode material, and an element which is capable of forming an alloy with lithium and/or an element compound which is capable of forming an alloy with lithium, each of which is capable of storage and release of lithium ions, may be used as a negative electrode material (negative electrode active material). Alternatively, known metal lithium, a carbonaceous material such as graphite, and an oxide material such as lithium titanate may be used.

As for the element which is capable of the alloying reaction with lithium, at least one is selected from Na, K, Rb, Cs, Fr, Be, Mg, Ca, Sr, Ba, Ra, Ti, Ag, Zn, Cd, Al, Ga, In, Si, Ge, Sn, Pb, Sb, and Bi. Among the above, silicon (Si) or tin (Sn) is preferred. The element compound containing the element capable of alloying reaction with lithium may preferably be a silicon compound or a tin compound. The silicon compound may preferably be SiOₓ (0.5≦x≦1.5). As for the tin compound, for example, a tin alloy (Cu-Sn alloy, Co-Sn alloy, etc.), a tin alloy (Cu-Sn alloy, Co-Sn alloy, etc.), and the like can be given. Among the above, the negative electrode active material may preferably contain silicon (Si), more preferably SiOₓ (0.5≦x≦1.5). While silicon has a large theoretical capacity, a volume change thereof during charge-discharge is undesirably large. Accordingly, the volume change is suppressed by using SiOₓ as silicon.

As an electrolyte solution, a solution obtained by dissolving a lithium salt such as lithium perchlorate, LiPF₆, LiBF₄, and LiCF₃SO₃ into a known nonaqueous solvent such as ethylene carbonate, dimethyl carbonate, propylene carbonate, and dimethyl carbonate at a concentration of 0.5 to 1.7 mol/L may be used. With the use of other known battery component parts, the battery may be assembled in accordance with an ordinary method.

The embodiments of the positive electrode active material, the nonaqueous electrolyte secondary battery, and the production process for positive electrode active material of the present invention are described in the foregoing, but the present invention is not limited to the above-described embodiments. The present invention can be carried out in various modes with alterations and improvements that can be attained by those skilled in the art within the range which does not deviate from the scope of the present invention.

### EXAMPLES

Hereinafter, the positive electrode active material, the nonaqueous electrolyte secondary battery, and the production process of the positive electrode active material of the present invention will specifically be described with an Example and a comparative Example.

### Example

### <Production of Positive Electrode Active Material>

### [Mixing Step]

100 parts by mass of Li₂FeSio₄ as a lithium silicate based compound and 10 parts by mass of AB as a carbon material are mixed in a mechano-fusion apparatus (manufactured by Hosokawa Micron Group) to obtain mixed particles. The treatment conditions were: a clearance of 1 mm; at 6000 rpm; a carrier gas (N₂) flow rate of 0.220 L/min; and a treatment time of 10 minutes.

### [Heating and Pressurizing Step]

The mixed particles obtained by the mixing step are molded into pellets each having a diameter of 15 mm. The pellets were subjected to a heating and pressurizing treatment by using an SPS apparatus (manufactured by Sumitomo Coal Mining Co., Ltd. (current company name: SPS Syntex Inc.)). The treatment conditions were: a treatment temperature of 700° C.; a treatment time of 5 minutes; a pressure of 30 MPa; and a supplied current of 480 A. The heating was conducted by heating to 700° C. at a temperature increase rate of 200° C./min and retaining at 700° C. for 5 minutes. With this step, a nonaqueous electrolyte secondary battery positive electrode active material of Example was obtained.

### <Production of Lithium Secondary Battery>

The positive electrode active material produced by the above-described step was used for producing a lithium secondary battery for evaluation purpose.

More specifically, a mixture of the positive electrode active material:acetylene black (AB):polytetrafluoroethylene (PTFE) =17.1:4.7:1 (mass ratio) was kneaded and then was formed into a film, and the film was compression-bonded to an aluminum current collector to produce an electrode. The electrode was subjected to vacuum drying at 140° C. for 3 hours to be used as a positive electrode. As a negative electrode, metallic lithium was used. As an electrolyte solution, a 1 mol/L solution obtained by dissolving LiPF₆ into ethylene carbonate (EC):dimethylene carbonate (DMC) =1:1 was used.

With the use of the positive electrode and the negative electrode described above, a coin battery was produced. More specifically, in a dry room, a separator (Celgard 2400 manufactured by Celgard, LLC.; a polypropylene microporous film having a thickness of 25 μm) and a nonwoven glass fabric filter (GA100 manufactured by Advantec and having a thickness of 440 μm) were disposed between the positive electrode and the negative electrode so as to be held therebetween, thereby obtaining an electrode body battery. The electrode body battery was housed in a battery case (CR2032 type coin battery member manufactured by Hohsen Corp.) made of a stainless container., The above-described electrolyte solution was injected into the battery case. The battery case was tightly sealed by a caulking machine to obtain a lithium secondary battery.

### Comparative Example

A positive electrode active material of Comparative Example was obtained by not subjecting the mixed particles obtained by the mixing step of Example to any heating and pressurizing step. A lithium secondary battery of Comparative Embodiment is the same as the lithium secondary battery of Embodiment except the positive electrode active material.

### <Analysis of Positive Electrode Active Material>

### [Bulk Density Measurement Test]

A bulk density (tap density) of each of the positive electrode active material of Example and the positive electrode active material of Comparative Example was measured by using a measuring cylinder. In the measurement, the masses of the positive electrode active material of Example and the positive electrode active material of Comparative Example were identical to each other, and the numbers of vibrations applied to the measuring cylinders were identical to each other. As a result, the tap density of the positive electrode active material of Comparative Example subjected only to the mixing step was 0.48 g/cm³, while the tap density of Example subjected to both of the mixing step and the heating and pressurizing step was 1.39 g/cm³ which is remarkably larger (about 2.9 times). From the result, it is understood that the bulk density of the positive electrode active material is increased by the heating and pressurizing step.

### [Particle Size Distribution Measurement Test]

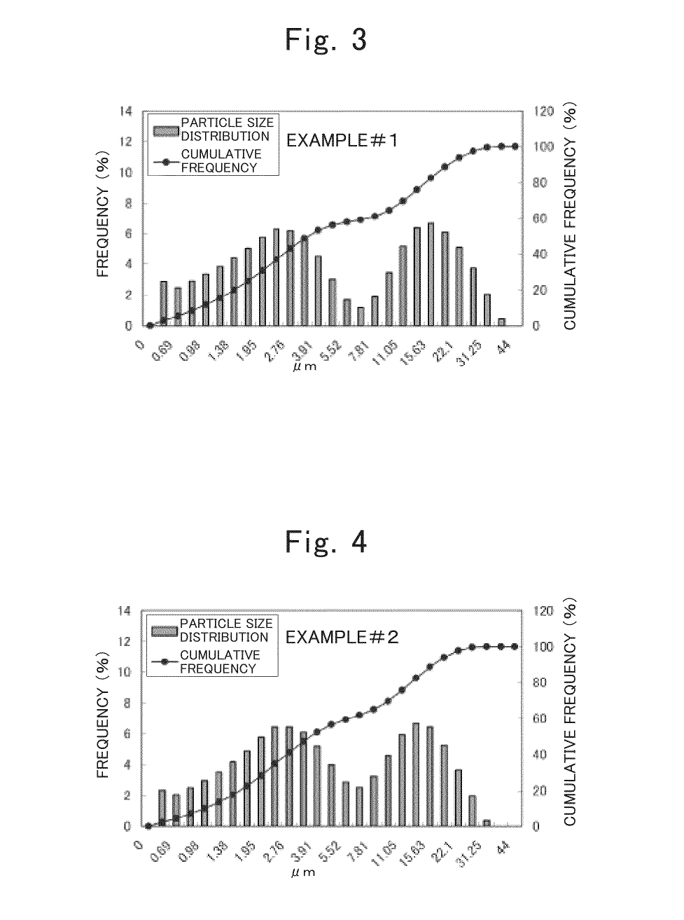

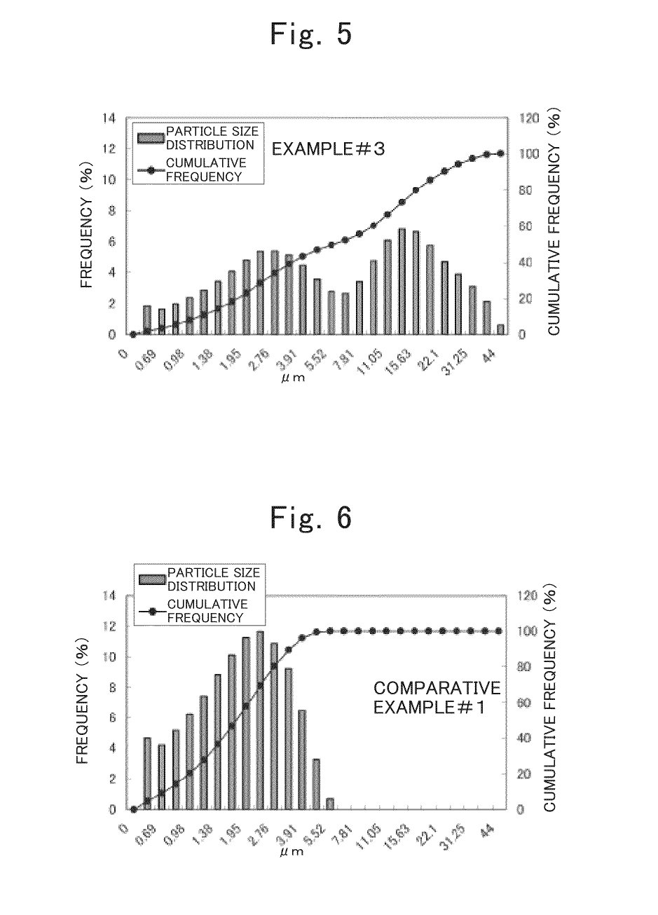

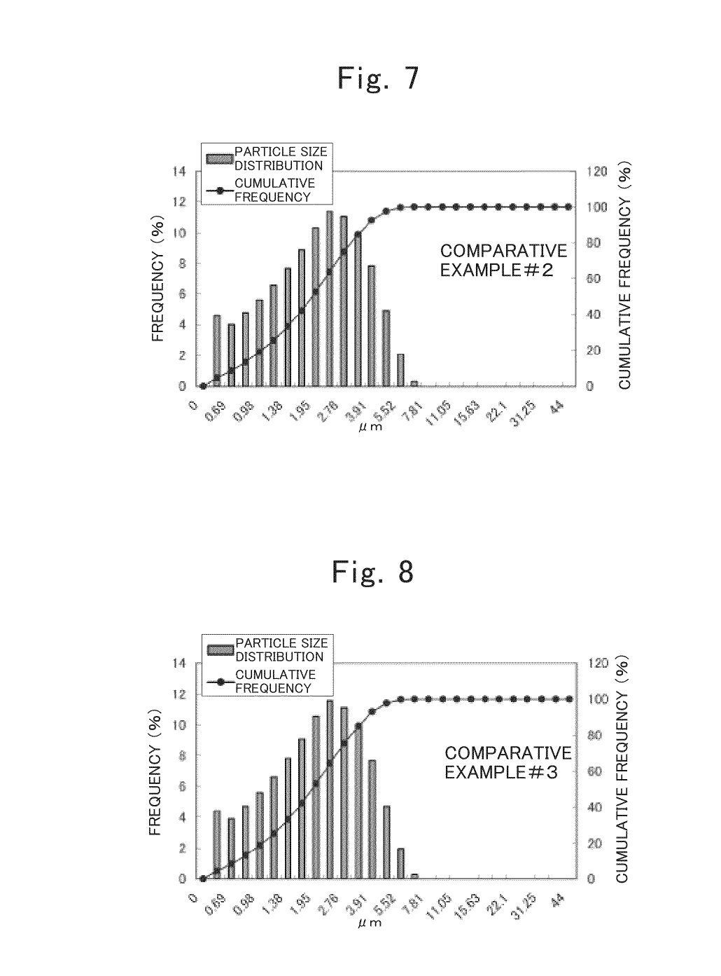

A particle size distribution (particle size distribution and cumulative frequency) of each of the positive electrode active material of Example and the positive electrode active material of Comparative Example was measured by a laser diffraction/scattering particle size distribution measurement method. As an apparatus, AEROTRAC SPR MODEL 7340 manufactured by Nikkiso Co., Ltd. was used. The particle size distribution was measured 3 times for each of the samples. Shown in FIGS. 3 to 5 are graphs illustrating the particle size distributions of the positive electrode active material of Example. Shown in FIGS. 6 to 7 are graphs illustrating the particle size distributions of the positive electrode active material of Comparative Example. The vertical axis on the left of each of the FIG indicates a frequency (%: an amount of particles having a particle diameter indicated by the horizontal axis) of each of bar charts of the FIG. The vertical axis on the right of each of the FIGS indicates a frequency (%: cumulative value of frequencies of presence of particles having a particle diameter indicated by the horizontal axis, and the sum of frequencies is 100%) in the line graph of the FIG. The cumulative frequencies of the positive electrode active materials are shown in Table 1.

TABLE 1

| | Example | | | Comparative Example | | |
|---|---|---|---|---|---|---|
| | #1 | #2 | #3 | #1 | #2 | #3 |
| D10 | 0.90 | 0.98 | 1.12 | 0.72 | 0.73 | 0.73 |
| D20 | 1.39 | 1.50 | 1.76 | 0.97 | 1.00 | 1.01 |
| D30 | 1.92 | 2.05 | 2.46 | 1.21 | 1.28 | 1.29 |
| D40 | 2.53 | 2.68 | 3.44 | 1.47 | 1.58 | 1.58 |
| D50 | 3.45 | 3.60 | 5.69 | 1.73 | 1.87 | 1.87 |
| D60 | 7.15 | 5.79 | 9.17 | 2.02 | 2.19 | 2.18 |
| D70 | 11.18 | 9.37 | 12.10 | 2.34 | 2.56 | 2.54 |
| D80 | 14.60 | 12.37 | 15.68 | 2.75 | 3.02 | 2.99 |
| D90 | 19.42 | 16.29 | 21.82 | 3.32 | 3.68 | 3.65 |

As shown in FIGS. 6 to 8, the particle size distribution of the positive electrode active material of Comparative Example is monodisperse having only one peak within the particle diameter range of 1.5 to 5.5 μm. A volume cumulative frequency D50 of the positive electrode active material of Comparative Example is about 1.7 to 1.9 μm which is out of the range of 2.0 to 15 μm. The particle size distribution of the positive electrode active material of Example is polydisperse having two peaks, i.e. one is within the particle diameter range of 1.5 to 5.5 μm and the other is within the particle diameter range of 12 to 30 μm. A volume cumulative frequency D50 of the positive electrode active material of Example is about 3.0 to 6.0 μm which is within the range of 2.0 to 15 μm. From the results, it is estimated that the peak in the particle diameter range of 1.5 to 5.5 μtm is the peak of the mixed particles, and the peak in the particle diameter range of 12 to 30 μm is the peak of secondary particles obtained by the heating and pressurizing step. Also, it is considered that D50 of the positive electrode active material of Example is increased since the mixed particles form the secondary particles by the heating and pressurizing step.

### [Surface Observation Test]

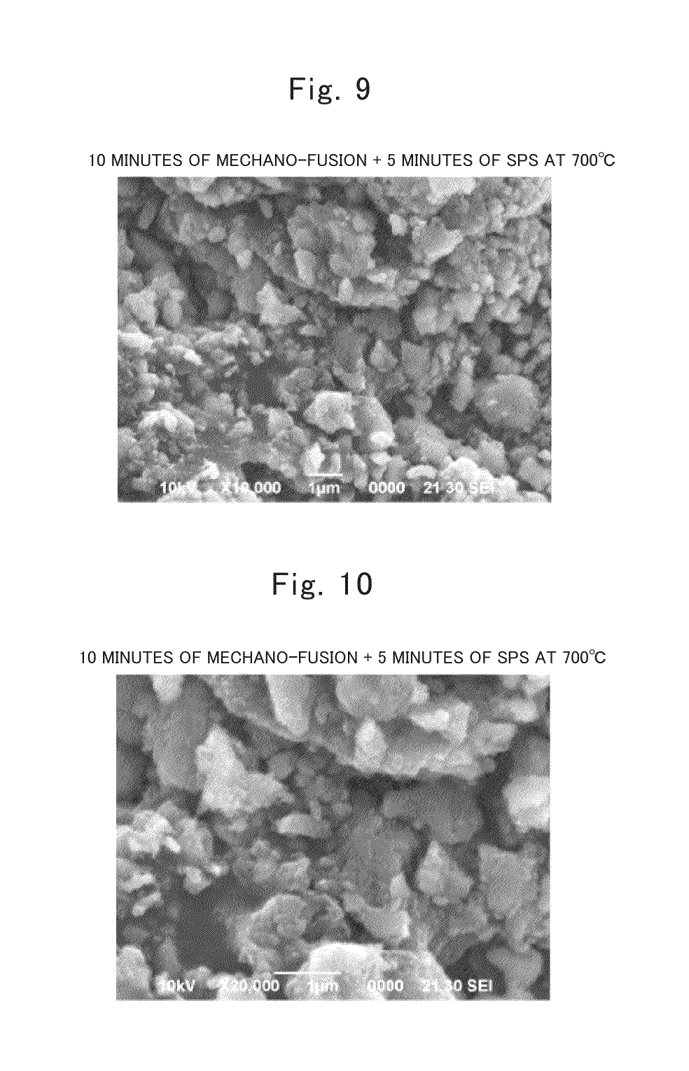

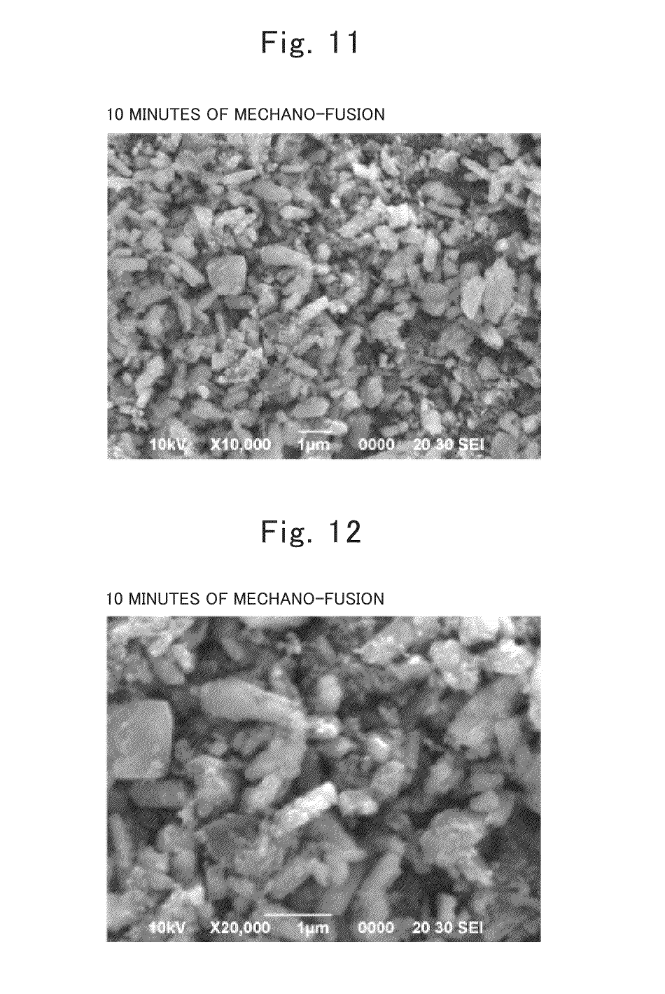

Surface observation of the positive electrode active material of Example and the positive electrode active material of Comparative Example was conducted by using a scanning electron microscope (SEM). Shown in FIGS. 9 and 10 are SEM images of the positive electrode active material of Example, and shown in FIGS. 11 and 12 are SEM images of the positive electrode active material of Comparative Example. Magnification in FIGS. 9 and 11 is ×10000, and magnification in FIGS. 10 and 12 is ×20000.

The positive electrode active material of Example shown in FIGS. 9 and 10 has more aggregations of the particles as compared to the positive electrode active material of Comparative Example shown in FIGS. 11 and 12. From the result, too, it is understood that the positive electrode active material of Example contains aggregates of the mixed particles, i.e. the secondary particles.

### [Conductivity Evaluation Test]

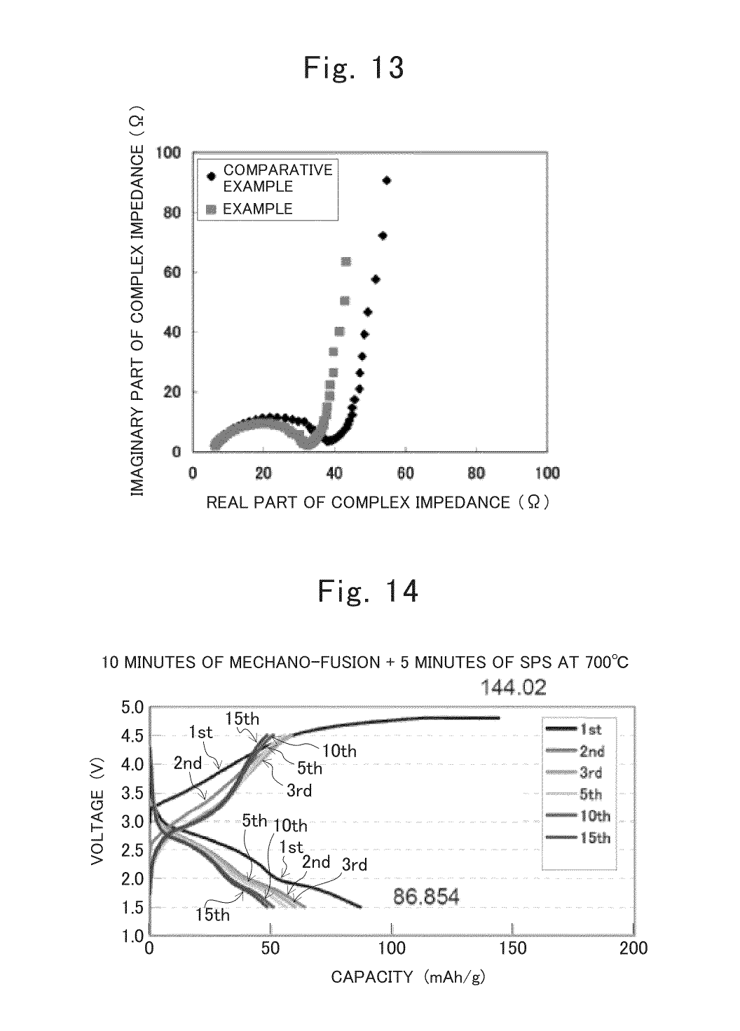

An internal resistance (impedance) after charging of each of the lithium secondary batteries of Example and Comparative Example was measured. More specifically, the measurement was conducted by using an electrochemical measurement apparatus (SI1280B manufactured by Solarton) at 0.1 to 20000 Hz and an alternating voltage of 10 mV. Measurement results are shown in FIG. 13.

As shown in FIG. 13, the lithium secondary battery of Example had the smaller internal resistance as compared to the lithium secondary battery of Comparative Example. More specifically, the internal resistance of the lithium secondary battery of Comparative Example was 34.723Ω, and the internal resistance of the lithium secondary battery of Example was 27.62Ω. Since the lithium secondary battery of Example and the lithium secondary battery of Comparative Example are different from each other only by the positive electrode active material, it can be said that the positive electrode active material of Example is superior in conductivity as compared to the positive electrode active material of Comparative Example. More specifically, it is understood from the result that the adhesion between the lithium silicate based compound and the carbon material is improved by performing the mixing step and the heating and pressurizing step, thereby enabling to produce the positive electrode active material superior in conductivity.

### [Cycle Test]

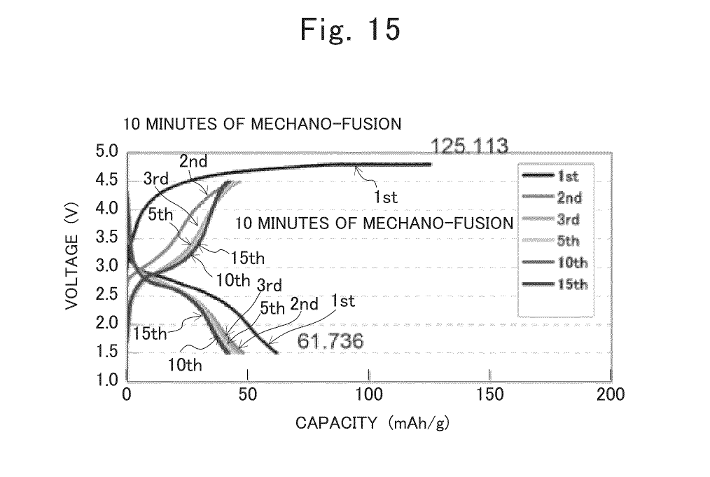

Charging/discharging of each of the lithium secondary batteries of Example and Comparative Example was performed repeatedly at 30° C. The charging-discharging of each of the batteries was conducted with a current value corresponding to 0.05 mA per unit area (1 cm²) of the positive electrode active material. A discharge termination voltage was 1.5 V, and a charge termination voltage was 4.5 V (provided that initial charge termination voltage was 4.8 V). A charge-discharge curve of the lithium secondary battery of Example is shown in FIG. 14, and a charge-discharge curve of the lithium secondary battery of Comparative Example is shown in FIG. 15. As shown in FIGS. 14 and 15, the lithium secondary battery of Example has a larger charge-discharge capacity as compared to the lithium secondary battery of Comparative Example. Since the lithium secondary battery of Example and the lithium secondary battery of Comparative Example are different from each other only by the positive electrode active material, it is considered that the difference of positive electrode active material influences the charge-discharge capacity. Also, the lithium ion secondary battery of Example has a lower average voltage at the initial charging as compared to Comparative Example. Therefore, the lithium ion secondary battery of Example is advantageous in the case of performing charging-discharging at a reduced charging voltage in the aim of reducing a load on the electrolyte solution. Therefore, it is understood from the results that, owing to the mixing step and the heating and pressurizing step performed on the lithium silicate based compound and the carbon material, the positive electrode active material superior in conductivity can be produced, thereby enabling to produce the nonaqueous electrolyte secondary battery having an even larger capacity. In other words, the positive electrode active material of the present invention which is produced from the lithium silicate based compound and the carbon material and has the two peaks in the particle size distribution is useful as the nonaqueous electrolyte secondary battery positive electrode active material.

1. A positive electrode active material for nonaqueous electrolyte secondary battery characterized by:
Comprising a lithium silicate based compound comprising lithium (Li), silicon (Si), oxygen (O), and a divalent transition metal element, and a carbon material comprising carbon (C)and
having two peaks in a particle size distribution measured by a laser diffraction/scattering particle size distribution measurement method.

2. The positive electrode active material for nonaqueous electrolyte secondary battery according to claim 1, wherein the divalent transition metal element is at least one kind of selected from iron (Fe), manganese (Mn), and cobalt (Co).

3. The positive electrode active material for nonaqueous electrolyte secondary battery according to claim 2, wherein the two peaks are respectively within the range of 1.5 μm or more and 5.5 μm or less and the range of 12 μm or more and 30 μm or less in the particle size distribution measured by the laser diffraction/scattering particle size distribution measurement method.

4. The positive electrode active material for nonaqueous electrolyte secondary battery according to claim 1, wherein a bulk density is 1.0 g/cm³ or more.

5. The positive electrode active material for
nonaqueous electrolyte secondary battery according to claim 1, wherein a value of a volume cumulative frequency D50 measured by the laser diffraction/scattering particle size distribution measurement method is 2.0 μpm or more and 15 μm or less.

6. A nonaqueous electrolyte secondary battery characterized in that a positive electrode thereof comprises the positive electrode active material according to claim 1.

7. A vehicle characterized by being mounted with the nonaqueous electrolyte secondary battery according to claim 6.

8. A production process for a positive electrode active material for a nonaqueous electrolyte secondary battery characterized by comprising:
a mixing step of mixing a lithium silicate based compound comprising lithium (Li), silicon (Si), oxygen (O), and a divalent transition metal element, with a carbon material comprising carbon (C) at 450 to 16000 rpm for 1 minute to 10 hours; and
a heating and pressurizing step of heating and pressurizing the mixture after the mixing step at 500° C. to 750° C. at 1 to 500 MPa for 1 minute to 15 hours.

9. The production process for the positive electrode active material for the nonaqueous electrolyte secondary battery according to claim 8, wherein the mixing step and/or the heating and pressurizing step are/is performed under an inert atmosphere.

10. The positive electrode active material for nonaqueous electrolyte secondary battery according to claim 1, wherein one of the two peaks is the peak of primary particles, and the other is the peak of the secondary particles in each of which a plurality of the primary particles are integrated.

11. The production process for the positive electrode active material for the nonaqueous electrolyte secondary battery according to claim 8, wherein the mixing step is the step for obtaining a mixture by applying a compression force and a shearing force.

12. The production process for the positive electrode active material for the nonaqueous electrolyte secondary battery according to claim 8, wherein a mechano-fusion treatment is performed in the mixing step.

13. A positive electrode active material for nonaqueous electrolyte secondary battery characterized by being produced by the production process for the positive electrode active material for the nonaqueous electrolyte secondary battery according to claim 8.
